(19) United States
(12) Patent Application Publication
(10) Pub. No.: US 2025/0242973 A1
(43) Pub. Date: Jul. 31, 2025

(54) Adjustable and Detachable Finger Grip Accessory

(71) Applicant: Lily Hudson Holdings LLC, Pinecrest, FL (US)

(72) Inventor: Marissa Gurdian, Mount Kisco, NY (US)

(73) Assignee: Lily Hudson Holdings LLC, Pinecrest, FL (US)

(21) Appl. No.: 18/975,692

(22) Filed: Dec. 10, 2024

Related U.S. Application Data
(60) Provisional application No. 63/627,388, filed on Jan. 31, 2024.

(51) Int. Cl. B65D 33/00

(52) U.S. Cl. CPC B65D 33/007

(57) ABSTRACT

A finger grip accessory (100) includes a U-shaped finger grip portion (102) having opposing finger rings (106a and 106b) on opposing legs (104a and 104b respectively) of the U-shaped finger grip portion and a flexible beaded strap member (108) coupled to the U-shaped finger grip portion, the strap member including a feed-through member (114) at a distal end of the strap member, an aperture (113) at an intermediate position (112) of the strap member, and a plurality of beads (110) disbursed along the length of the strap member. In some embodiments, the feed-through member and each bead in the plurality of beads of the strap member have a diameter larger than the diameter of the aperture. In some embodiments, the U-shaped finger grip portion can further include textured features (105) on opposing leg portions of the U-shaped finger grip portion

### CROSS-REFERENCE TO RELATED APPLICATIONS

This application claims priority to U.S. Provisional Patent Application No. 63/627,388 entitled “Adjustable and Detachable Finger Grip Accessory” filed Jan. 31, 2024, which is expressly incorporated herein by reference in its entirety to form part of the present disclosure.

### TECHNICAL FIELD

The present disclosure is directed to an apparatus for assisting in the gripping and opening of bags using primarily a thumb and a secondary finger.

### BACKGROUND

### Description of the Related Art

Current devices and methods to address the issue of opening plastic bags include finger cots and other gripping devices that lack adjustability for various size fingers. Furthermore, finger cots are prone to getting misplaced or lost when used as an independent device that is unable to attach to a leash or other pet handling instrument, or to a handbag strap, work pushcart, shopping cart handle, key ring, produce bag stand display, cashier station, or other implement Although there are a number of attachment mechanisms for attaching an item to a leash or a carabiner, none are currently integrated and readily adjustable for various configurations on leashes or other pet implements, handbag straps, work pushcarts, shopping cart handles, key rings, produce bag stand displays, cashier stations, or other implements.

### BRIEF DESCRIPTION OF THE DRAWINGS

FIG. 1A illustrates a perspective view of a finger grip accessory in accordance with the embodiments;

FIG. 1B illustrates a perspective view of another finger grip accessory in accordance with the embodiments;

FIG. 2 illustrates a front view of the finger grip accessory of FIG. 1A in accordance with the embodiments;

FIG. 3 illustrates a rear view of the finger grip accessory of FIG. 1A in accordance with the embodiments;

FIG. 3 illustrates a rear view of the finger grip accessory of FIG. 1A in accordance with the embodiments;

FIG. 4 illustrates a top view of the finger grip accessory of FIG. 1A in accordance with the embodiments;

FIG. 5 illustrates a bottom view of the finger grip accessory of FIG. 1A in accordance with the embodiments;

FIG. 6 illustrates a left view of the finger grip accessory of FIG. 1A in accordance with the embodiments;

FIG. 7 illustrates a right view of the finger grip accessory of FIG. 1A in accordance with the embodiments;

FIG. 8A illustrates a perspective view of a finger grip accessory with an attachment portion in a bent position in accordance with the embodiments;

FIG. 8B illustrates a perspective view of another finger grip accessory in accordance with the embodiments;

FIG. 8C illustrates a perspective of another finger grip accessory having a different beaded strap member in accordance with the embodiments;

FIG. 9 illustrates the finger grip accessory on a leash or carabiner in accordance with the embodiments; and

FIG. 10 illustrates a perspective view of a finger grip accessory further including a key ring with a grocery shopping cart token.

### SUMMARY

In some embodiments, a finger grip accessory includes a U-shaped finger grip portion having opposing finger rings on opposing legs of the U-shaped finger grip portion and a flexible beaded strap member coupled to the U-shaped finger grip portion, the strap member including a feed-through member at a distal end of the strap member, an aperture at an intermediate position of the strap member, and a plurality of beads disbursed along the length of the strap member. In some embodiments, the feed-through member and each bead in the plurality of beads of the strap member have a diameter larger than the diameter of the aperture.

In some embodiments, the U-shaped finger grip portion and the flexible beaded strap member are integrally coupled.

In some embodiments, the U-shaped finger grip portion and the flexible beaded strap member are formed from a unitary piece of silicone material.

In some embodiments, the feed-through member, plurality of beads, and aperture are arranged and configured to enable adjustable length attachments to a leash, a leash loop handle, a carabiner on a leash, a handbag strap, a work pushcart, a shopping cart handle, a key ring, a key ring with a grocery shopping cart token, a produce bag stand display, a cashier station, or other implement.

In some embodiments, the finger grip accessory is entirely constructed of a dishwasher safe material made of silicone.

In some embodiments, the U-shaped finger grip portion further includes textured features on at least opposing inner leg portions of the U-shaped finger grip portion. In some embodiments, the textured features are cross-member features configured for easier opening of a plastic bag in any direction.

In some embodiments, the U-shaped finger grip portion further includes textured features on inner and outer surfaces of opposing leg portions of the U-shaped finger grip portion.

In some embodiments, the finger ring loops are arranged and constructed of flexible silicone material allowing a one-size fit all configuration.

In some embodiments, a finger grip accessory for gripping and opening plastic bags can include a U-shaped finger grip portion having opposing finger rings on opposing legs of the U-shaped finger grip portion, textured features on at least opposing inner leg portions of the U-shaped finger grip portion, and a flexible beaded strap member coupled to the U-shaped finger grip portion, the strap member including a feed-through member at a distal end of the strap member, an aperture at an intermediate position of the strap member, and a plurality of embedded beads disbursed along the length of the strap member. In some embodiments, the feed-through member and each bead in the plurality of embedded beads of the strap member have a diameter larger than the diameter of the aperture.

In some embodiments, the U-shaped finger grip portion and the flexible beaded strap member are integrally coupled.

In some embodiments, the U-shaped finger grip portion and the flexible beaded strap member are formed from a unitary piece of silicone material.

In some embodiments, the feed-through member, plurality of beads, and aperture are arranged and configured to enable adjustable length attachments to a leash, a leash loop handle, a carabiner on a leash, a handbag strap, a work pushcart, a shopping cart handle, a key ring, a key ring with a grocery shopping cart token, a produce bag stand display, a cashier station, or other implement.

In some embodiments, the finger grip accessory is entirely constructed of a dishwasher safe material made of silicone.

In some embodiments, the textured features are cross-member features configured for easier opening of a plastic bag in any direction.

In some embodiments, the U-shaped finger grip portion further includes the textured features on inner and outer surfaces of opposing leg portions of the U-shaped finger grip portion.

In some embodiments, a grip accessory for gripping and opening plastic bags can include a unitary molded silicone part that includes a U-shaped finger grip portion having opposing legs, and flexible finger rings on each of the opposing legs of the U-shaped finger grip portion. Note that some embodiments do not necessarily include a strap member.

In some embodiments, the grip accessory further includes textured features on at least opposing inner leg portions of the U-shaped finger grip portion, and a flexible beaded strap member coupled to the U-shaped finger grip portion, the strap member including a tapered feed-through member at a distal end of the strap member, an aperture at an intermediate position of the strap member, and a plurality of embedded beads disbursed along the length of the strap member. In some embodiments, the tapered feed-through member and each bead in the plurality of embedded beads of the strap member have a diameter larger than the diameter of the aperture.

In some embodiments, the feed-through member, plurality of beads, and aperture are arranged and configured to enable adjustable length attachments to a leash, a leash loop handle, a carabiner on a leash, a handbag strap, a work pushcart, a shopping cart handle, a key ring, a key ring with a grocery shopping cart token, a produce bag stand display, a cashier station, or other implement.

In some embodiments, the textured features are cross-member features configured for easier opening of a plastic bag in any direction.

In some embodiments, the U-shaped finger grip portion further includes the textured features on inner and outer surfaces of opposing leg portions of the U-shaped finger grip portion.

### DETAILED DESCRIPTION

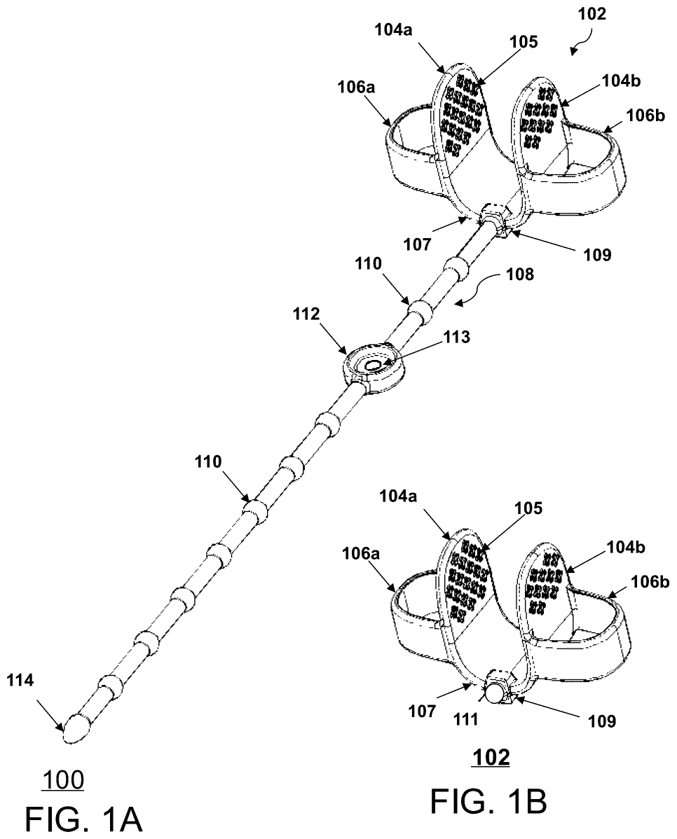

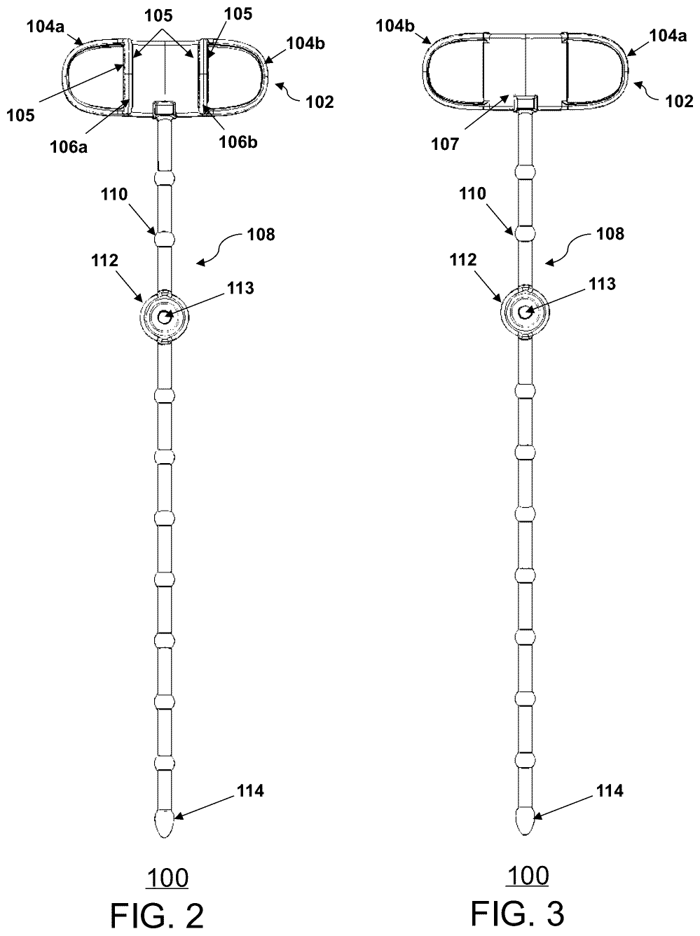

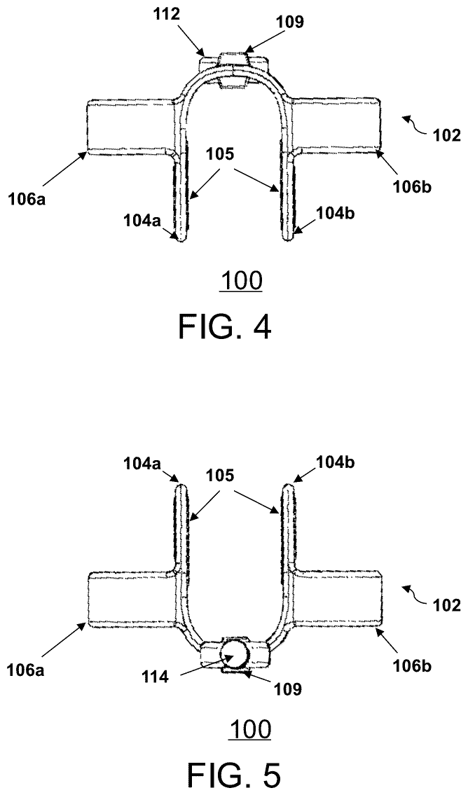

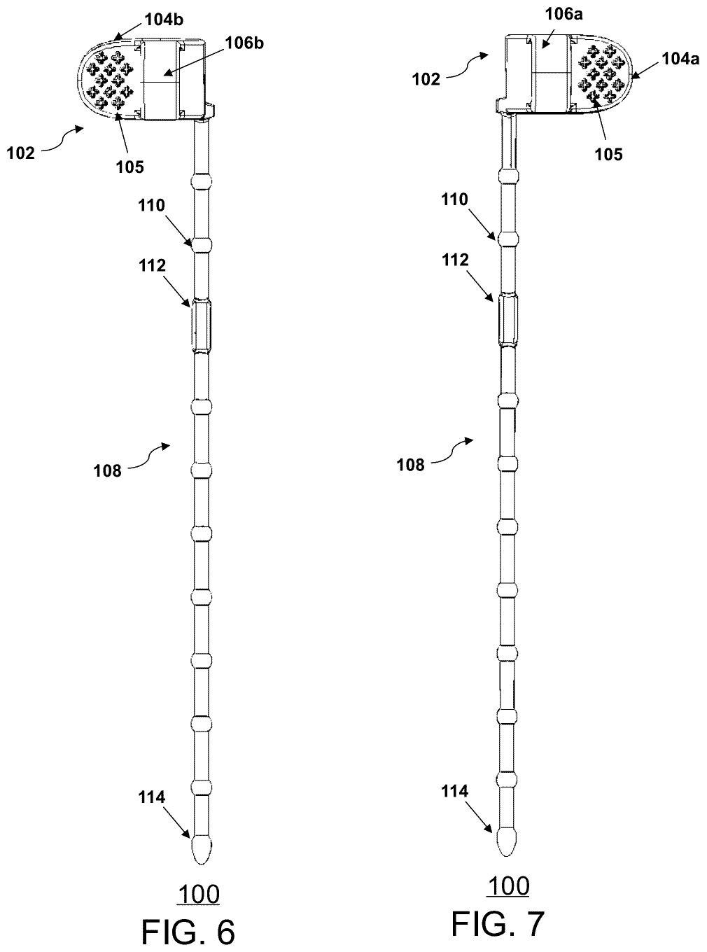

Referring to FIGS. 1A, 1B, and 2-7, a finger grip accessory 100 in some embodiments includes a U-shaped finger grip portion 102 having opposing finger rings 106a and 106b on opposing legs (104a and 104b respectively) of the U-shaped finger grip portion. Some embodiments further include a flexible beaded strap member 108 coupled to the U-shaped finger grip portion 102, the strap member 108 including a feed-through member 114 at a distal end of the strap member, an aperture 113 at an intermediate position 112 of the strap member 108, and a plurality of beads 110 disbursed along the length of the strap member. In some embodiments, the feed-through member 114 and each bead 110 in the plurality of beads of the strap member 108 have a diameter larger than the diameter of the aperture 113.

Some embodiments as shown in FIG. 1B do not include the flexible beaded strap member 108 and just includes the U-shaped finger grip portion 102 having the opposing finger rings 106a and 106b on opposing legs 104a and 104b. The finger grip portion 102 can also include a U-shaped member 107 that can include a juncture 109. In some embodiments, the U-shaped finger grip portion 102 can further include an aperture 111 that can be left alone or alternatively used as a receptable for a detachable strap member. Note that the U-shaped finger grip portion 102 can serve as a stand-alone product.

In some embodiments, the U-shaped finger grip portion 102 and the flexible beaded strap member 108 are integrally coupled as shown in FIG. 1A. In some embodiments, the portion 102 and member 108 can be formed from a unitary mold and in yet other embodiments, the portion 102 and member 108 can be separate elements attached together using adhesive at a juncture 109. The juncture 109 can be part of a U-shaped member 107 that forms a part of the U-shaped finger grip portion 102. In some embodiments, the U-shaped finger grip portion 102 and the flexible beaded strap member 108 are formed from a unitary piece of silicone material. The embodiments are not necessarily limited to silicone material and other materials such as other forms of rubber or polymers can be used. In some embodiments, the finger grip accessory 100 is entirely constructed of a dishwasher safe material made of silicone. As noted above, the strap member can alternatively be detachable and selectively coupled to the U-shaped finger grip portion 102.

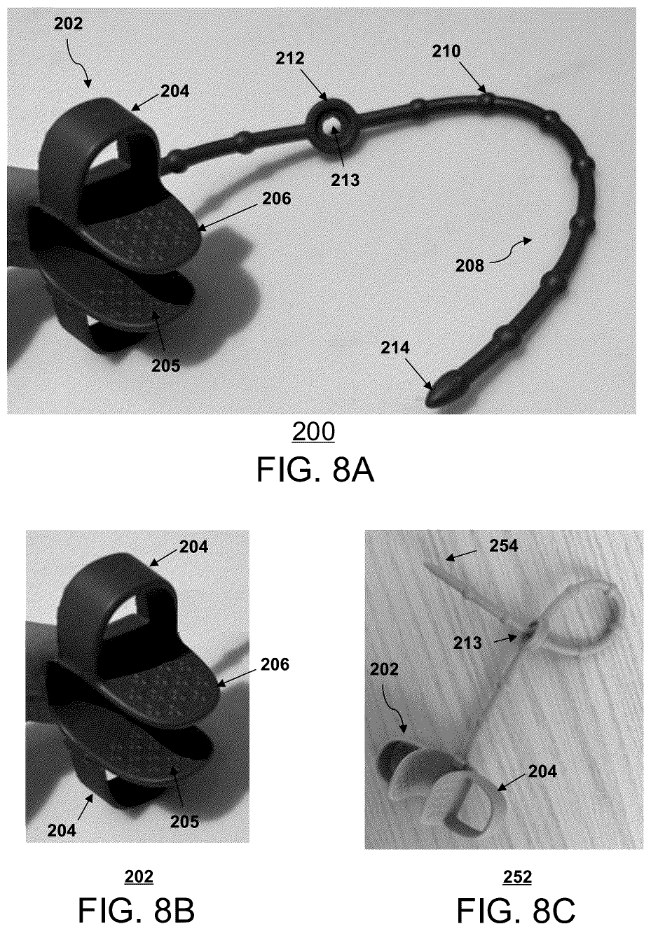

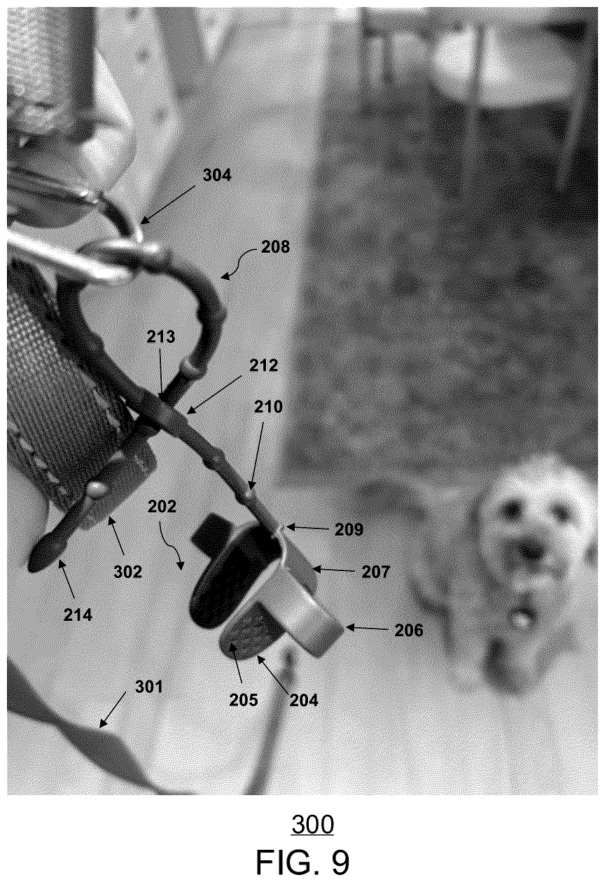

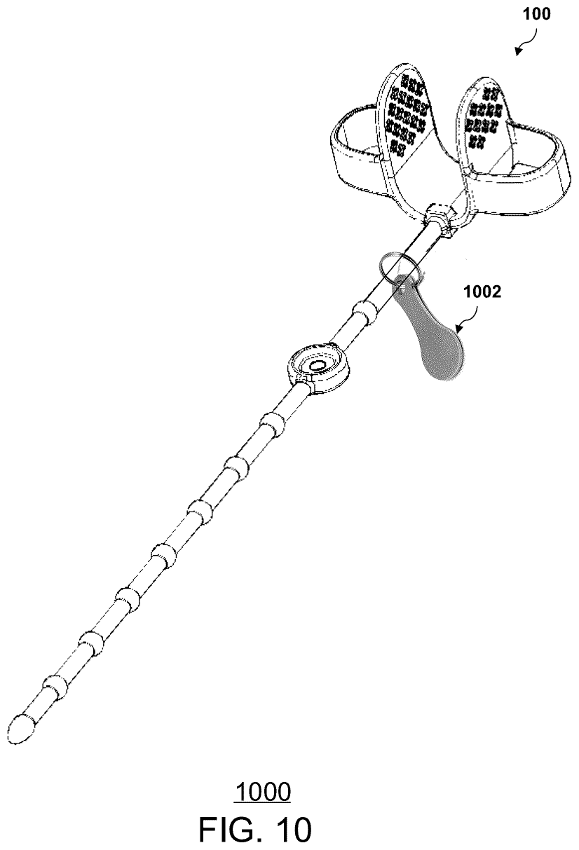

In some embodiments, the feed-through member 114, plurality of beads 110, and aperture 113 are arranged and configured to enable adjustable length attachments to a leash, a leash loop handle, or a carabiner on a leash (see FIGS. 8A and 9). The possible attachments using the strap member are not just limited to leashes but can be configured to enable adjustable length attachments to almost any item including any one among a leash, a leash loop handle, a carabiner on a leash, a handbag strap, a work pushcart, a shopping cart handle, a key ring, a key ring with a grocery shopping cart token, a produce bag stand display, a belt buckle, a belt loop on a pair of pants, or a cashier station. For example, an assembly 1000 of FIG. 10 having the finger grip accessory 100 can attach to a key ring with a grocery shopping cart token 1002 as shown. Such assembly can serve the multiple purposes of having easy access to a bag opening device and a device that allows access to or unlocks certain locked shopping carts and return of the token upon returning the shopping cart back to a locked state.

In some embodiments, the U-shaped finger grip portion 102 further includes textured features 105 on at least opposing inner leg portions (104a and 104b) of the U-shaped finger grip portion 102. In some embodiments, the textured features 105 are cross-member features configured for easier opening of a plastic bag in any direction. Of course, the embodiments are not limited to cross-member features, but generally a pattern or almost any shape or even a random pattern that provides better gripping functionality is desired. In some embodiments, the U-shaped finger grip portion 102 further includes textured features on not only inner, but also outer surfaces of opposing leg portions (104a and 104b) of the U-shaped finger grip portion.

In some embodiments, the finger ring loops 106a and 106b are arranged and constructed of flexible silicone material allowing a one-size fit all configuration. Other materials that are flexible or pliable and/or resilient can be used instead of the silicone material.

In some embodiments, a finger grip accessory 100 for gripping and opening plastic bags can include a U-shaped finger grip portion 102 having opposing finger rings (106a and 106b) on opposing legs (104a and 104b respectively) of the U-shaped finger grip portion, textured features 105 on at least opposing inner leg portions of the U-shaped finger grip portion, and a flexible beaded strap member 108 coupled to or integrated with the U-shaped finger grip portion 102, the strap member 108 including a feed-through member 114 at a distal end of the strap member, an aperture 113 at an intermediate position 112 of the strap member, and a plurality of embedded beads 110 disbursed along the length of the strap member. In some embodiments, the feed-through member 114 and each bead 110 in the plurality of embedded beads of the strap member 108 have a diameter larger than the diameter of the aperture 113. As noted above, in some embodiments, the U-shaped finger grip portion 102 and the flexible beaded strap member 108 are integrally coupled and in some embodiments can be formed from a unitary piece of silicone material. In some embodiments, the finger grip accessory 100 is entirely constructed of a dishwasher safe material made of silicone.

In some embodiments, the feed-through member 114, plurality of beads 110, and aperture 113 are arranged and configured to enable adjustable length attachments to a leash, a leash loop handle, or a carabiner on a leash as shown in 9.

In some embodiments, the textured features 105 are cross-member features configured for easier opening of a plastic bag in any direction. The cross-member features are just one pattern that can be used to provide better gripping. In this regard, other patterns can be used as well. In some embodiments, the U-shaped finger grip portion 102 further includes the textured features 105 on inner and outer surfaces of opposing leg portions 104a and 104b of the U-shaped finger grip portion 102.

In some embodiments as shown in FIG. 8A or 9, for example, a grip accessory 200 for gripping and opening plastic bags can include a unitary molded silicone part that includes a U-shaped finger grip portion 202 having opposing legs 206, flexible finger rings 204 on each of the opposing legs 206 of the U-shaped finger grip portion 202, textured features 205 on at least opposing inner leg portions of the U-shaped finger grip portion, and a flexible beaded strap member 208 coupled to the U-shaped finger grip portion, the strap member including a tapered feed-through member 214 at a distal end of the strap member 208, an aperture 213 at an intermediate position 212 of the strap member, and a plurality of embedded beads 210 disbursed along the length of the strap member. In some embodiments, the portion 202 and member 208 can be formed from a unitary mold and in yet other embodiments, the portion 202 and member 208 can be separate elements attached together using adhesive at a juncture 209. The juncture 209 can be part of a U-shaped member 207 that forms a part of the U-shaped finger grip portion 202. In some embodiments, the tapered feed-through member 214 and each bead 210 in the plurality of embedded beads of the strap member 208 have a diameter larger than the diameter of the aperture 213. For example, the tapered feed-through member 214 can have a bulbous head shape that has a diameter larger than the diameter of the aperture 213. In some embodiments as illustrated in a grip accessory 252 (similar to grip accessory 200 of FIG. 8A) as shown in FIG. 8C, the grip accessory 252 can include the U-shaped finger grip portion and flexible finger rings 204 as well as flexible beaded member 208 that has a tapered end 254 that does not necessarily have a diameter larger than the diameter of the aperture 213.

In some embodiments, the textured features 205 are cross-member features configured for easier opening of a plastic bag in any direction.

In some embodiments, the U-shaped finger grip portion 202 further includes the textured features 205 on inner and outer surfaces of opposing leg portions 206 of the U-shaped finger grip portion 202.

As noted above, some embodiments of a finger grip accessory for gripping and opening plastic bags can just include the U-shaped finger grip portion 202 shown in FIG. 8B having opposing finger rings 204 on opposing legs 205 and 206 of the U-shaped finger grip portion 202 (without the strap member).

In some embodiments, the feed-through member 214, plurality of beads 210, and aperture 213 are arranged and configured in an assembly 300 to enable adjustable length attachments to a leash 301, a leash loop handle 302, or a carabiner 304 on a leash as shown in FIG. 9.

In interpreting the present disclosure and the claims, references of the form “A and/or B” encompass any and every combination and sub-combination of elements A and B, namely, any or all of the following: (i.) A, (ii.) B, (iii.) A or B, and (iv.) A and B. References of the form “A, B, and/or C” likewise encompass any and every combination and subcombination of elements A, B and C). Where the present disclosure or any of the claims may recite “a” or “a first” item or the equivalent thereof, such disclosure includes one or more such items and does not require or exclude two or more such items. Numerical or ordinal terms such as “first”, “second”, “third” etc. when used to refer to items are used solely to identify the items, and do not require or limit the number of such items elements and do not indicate, require or limit a particular position or order of such items unless expressly and clearly stated otherwise.

Descriptions made with reference to “embodiment”, “embodiments”, “some embodiments”, “an embodiment”, “preferred embodiment”, “other embodiments” “alternative embodiments”, “various embodiments” or the like mean that the description is applicable to at least one embodiment of the invention but not necessarily all embodiments. The terms “comprising,” “including,” “having,” and the like, as used with respect to one or more embodiments, are synonymous. In some cases features, items steps or other subject matter are described herein as being optional or using terms such as “optional” or “optionally”. However, lack use of such terms in connection with the description of any other features, items steps or other subject matter does not in any way mean or imply that such other features, items steps or other subject matter are required or are not optional.

As an aid to understanding, various actions, operations or steps may sometimes be presented herein or described herein in sequence. However, the order of description or written presentation herein is not to be construed to mean or imply that such must necessarily occur in a corresponding order or sequence unless otherwise expressly and clearly stated or logically essential. Some actions, operations or steps may permissibly be performed in an order or sequence other than the order of their description or written presentation herein unless otherwise expressly and clearly stated or logically essential. Unless otherwise expressly and clearly stated or logically essential, actions, operations or steps described herein may be combined or divided. Unless otherwise expressly and clearly stated or logically essential, any description herein of any one or more actions, operations or steps does not preclude any one or more other preceding, succeeding and/or intervening actions, operations or steps irrespective of whether or not such preceding, succeeding and/or intervening actions, operations or steps are described or disclosed herein.

Unless otherwise expressly and clearly stated or logically essential, any illustration, description, or reference herein of any one or more items, structures or elements being “connected to”, “coupled to”, “joined to”, “joined with”, “attached to”, “mounted to”, “mounted in” or “secured to” any one or more other specified items, structures or elements shall not be construed to preclude such connection, coupling, joint, attachment, mounting or securement being either made indirectly, by way of one or more other specified or unspecified items structures or elements, or being made directly.

Unless otherwise expressly and clearly stated or logically essential, any illustration, description, or reference herein of any one or more items, structures or elements “adjoining”, any one or more other specified items, structures or elements, shall be construed to permit that such may adjoin either direct or indirectly. The term “adjoining” permits, but does not require, preclude the presence of items, structures or elements interposed between those describes as adjoining. Unless otherwise expressly and clearly stated or logically essential, any illustration, description, or reference herein to any one or more items, structures or elements being “beneath”, “below”, “above”, “behind”, “in front of”, “between”, “under”, “over”, “in”, “within”, “outside”, “inside” any one or more other specified items, structures or elements and/or any other prepositions or prepositional phrases shall construed in a manner which permits, but does not require, contact or immediacy and any and all other prepositions and/or prepositional phrases shall be construed in that same manner.

As used herein, the term “material” encompasses, without limitation, unblended materials having a single constituent, blended materials having two or more constituents, composite materials, homogeneous materials and non-homogeneous materials.

While the invention has been described with reference to various preferred embodiments, it will be understood by those skilled in the art that various changes may be made and equivalents substituted for elements thereof without departing from the scope of the invention and that modifications may be made to adapt to a particular situation or application of the invention without departing from the scope of the invention. The invention is not limited to the particular embodiments disclosed. Rather, the invention covers all embodiments which are within the scope of the claims, either literally or under the Doctrine of Equivalents.

1. A finger grip accessory, comprising:
a U-shaped finger grip portion having opposing finger rings on opposing legs of the U-shaped finger grip portion; and
a flexible beaded strap member coupled to the U-shaped finger grip portion, the strap member including a feed-through member at a distal end of the strap member, an aperture at an intermediate position of the strap member, and a plurality of beads disbursed along the length of the strap member;
wherein the feed-through member and each bead in the plurality of beads of the strap member have a diameter larger than the diameter of the aperture.

2. The finger grip accessory of claim 1, wherein the U-shaped finger grip portion and the flexible beaded strap member are integrally coupled.

3. The finger grip accessory of claim 1, wherein the U-shaped finger grip portion and the flexible beaded strap member are formed from a unitary piece of silicone material.

4. The finger grip accessory of claim 1, wherein the feed-through member, plurality of beads, and aperture are arranged and configured to enable adjustable length attachments to any one among a leash, a leash loop handle, a carabiner on a leash, a handbag strap, a work pushcart, a shopping cart handle, a key ring, a key ring with a grocery shopping cart token, a produce bag stand display, or a cashier station.

5. The finger grip accessory of claim 1, wherein the finger grip accessory is entirely constructed of a dishwasher safe material made of silicone.

6. The finger grip accessory of claim 1, wherein the U-shaped finger grip portion further includes textured features on at least opposing inner leg portions of the U-shaped finger grip portion.

7. The finger grip accessory of claim 6, wherein the textured features are cross-member features configured for easier opening of a plastic bag in any direction.

8. The finger grip accessory of claim 1, wherein the U-shaped finger grip portion further includes textured features on inner and outer surfaces of opposing leg portions of the U-shaped finger grip portion.

9. The finger grip accessory of claim 1, wherein the finger ring loops are arranged and constructed of flexible silicone material allowing a one-size fits all configuration.

10. A finger grip accessory for gripping and opening plastic bags, comprising:
a U-shaped finger grip portion having opposing finger rings on opposing legs of the U-shaped finger grip portion;
textured features on at least opposing inner leg portions of the U-shaped finger grip portion; and
a flexible beaded strap member coupled to the U-shaped finger grip portion, the strap member including a feed-through member at a distal end of the strap member, an aperture at an intermediate position of the strap member, and a plurality of embedded beads disbursed along the length of the strap member;
wherein the feed-through member and each bead in the plurality of embedded beads of the strap member have a diameter larger than the diameter of the aperture.

11. The finger grip accessory of claim 10, wherein the U-shaped finger grip portion and the flexible beaded strap member are integrally coupled.

12. The finger grip accessory of claim 10, wherein the U-shaped finger grip portion and the flexible beaded strap member are formed from a unitary piece of silicone material.

13. The finger grip accessory of claim 10, wherein the feed-through member, plurality of beads, and aperture are arranged and configured to enable adjustable length attachments to any one among a leash, a leash loop handle, a carabiner on a leash, a handbag strap, a work pushcart, a shopping cart handle, a key ring, a produce bag stand display, or a cashier station.

14. The finger grip accessory of claim 10, wherein the finger grip accessory is entirely constructed of a dishwasher safe material made of silicone.

15. The finger grip accessory of claim 10, wherein the textured features are cross-member features configured for easier opening of a plastic bag in any direction.

16. The finger grip accessory of claim 10, wherein the U-shaped finger grip portion further includes the textured features on inner and outer surfaces of opposing leg portions of the U-shaped finger grip portion.

17. A finger grip accessory for gripping and opening plastic bags, comprising:
a unitary molded silicone part, comprising:
a U-shaped finger grip portion having opposing legs; and
flexible finger rings on each of the opposing legs of the U-shaped finger grip portion.

18. The finger grip accessor of claim 17, further comprising: textured features on at least opposing inner leg portions of the U-shaped finger grip portion; and
a flexible beaded strap member coupled to the U-shaped finger grip portion, the strap member including a tapered feed-through member at a distal end of the strap member, an aperture at an intermediate position of the strap member, and a plurality of embedded beads disbursed along the length of the strap member;
wherein the tapered feed-through member and each bead in the plurality of embedded beads of the strap member have a diameter larger than the diameter of the aperture.

19. The finger grip accessory of claim 18, wherein the feed-through member, plurality of beads, and aperture are arranged and configured to enable adjustable length attachments to any one among a leash, a leash loop handle, a carabiner on a leash, a handbag strap, a work pushcart, a shopping cart handle, a key ring, a key ring with a grocery shopping cart token, a produce bag stand display, or a cashier station.

20. The finger grip accessory of claim 18, wherein the textured features are cross-member features configured for easier opening of a plastic bag in any direction.
